(19) United States
(12) Patent Application Publication
(10) Pub. No.: US 2003/0236823 A1
(43) Pub. Date: Dec. 25, 2003

(54) Information sharing groups, server and client group applications, and methods therefor

(76) Inventors: Robert Patzer, Lake Zurich, IL (US); Bin Hu, Mountain View, CA (US); Dmitri Latypov, San Mateo, CA (US)

Correspondence Address: MOTOROLA INC, 600 NORTH US HIGHWAY 45, LIBERTYVILLE, IL, 60048-5343, US

(21) Appl. No.: 10/174,615

(22) Filed: Jun. 19, 2002

(51) Int. Cl. G06F 15/16

(52) U.S. Cl. 709/203

(57) ABSTRACT

Methods for creating (310) information-sharing groups on communications servers, and automatically deleting (320) the information-sharing groups after a specified group validity time interval expires (340) by associating an auto-delete property (330) with the information-sharing group. The group is preferably deleted only if there is no active group session (350). The auto-delete property and any validity time period property are specified in a group property primitive generated by a group application, running for example on a client, which transmits the primitive to the server.

### FIELD OF THE INVENTIONS

The present inventions relate generally to information sharing groups, and more particularly to the creation and deletion of information sharing groups, for example those hosted by Internet service providers and on other communications servers. The inventions relate also to server and client group applications, including those run on wireless communications handsets, group properties, and methods therefor.

### BACKGROUND OF THE INVENTIONS

It is known generally to create and host information sharing groups including chat rooms, news groups and other discussion forums, on communications servers, for example on Internet service provider (ISP) servers including those of America On-Line and others. The groups may be created by service providers and server hosts or by users, for example by ISP subscribers and members.

Server-based information sharing groups are created generally in a create group transaction conducted at a create group user interface after logging onto a host server. Upon creation of a new group, a unique identification is assigned to the group, usually by a server application. The group creator generally specifies group one or more properties, for example in a set group property transaction. Known group properties include, for example, group name and group topic, both of which are usually assigned or designated by the group creator. The group properties may also specify attributes of group membership, for example whether group membership is “private” or “public” and “open” or “restricted”, limits on group membership size, etc. Other known group properties include whether the group supports private messaging, and whether the group is searchable. Some properties are specified by the group server, whereas others may be specified by the group creator. Other group properties assume default values if not set by the creator. Presently, information sharing groups must be deleted manually, either by the server or by the group creator.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is a schematic block diagram of an exemplary communications architecture having group-hosting servers accessible by wireless and other clients.

FIG. 2 is a more detailed schematic block diagram of an exemplary group server architecture having group service functionality.

FIG. 3 is an exemplary group creation and deletion process flow diagram.

FIG. 4 is an exemplary group property selection process flow diagram.

FIG. 5 is an exemplary group configuration file having group property data fields.

FIG. 6 is a schematic application generated information-sharing group property primitive.

### DETAILED DESCRIPTION OF THE INVENTIONS

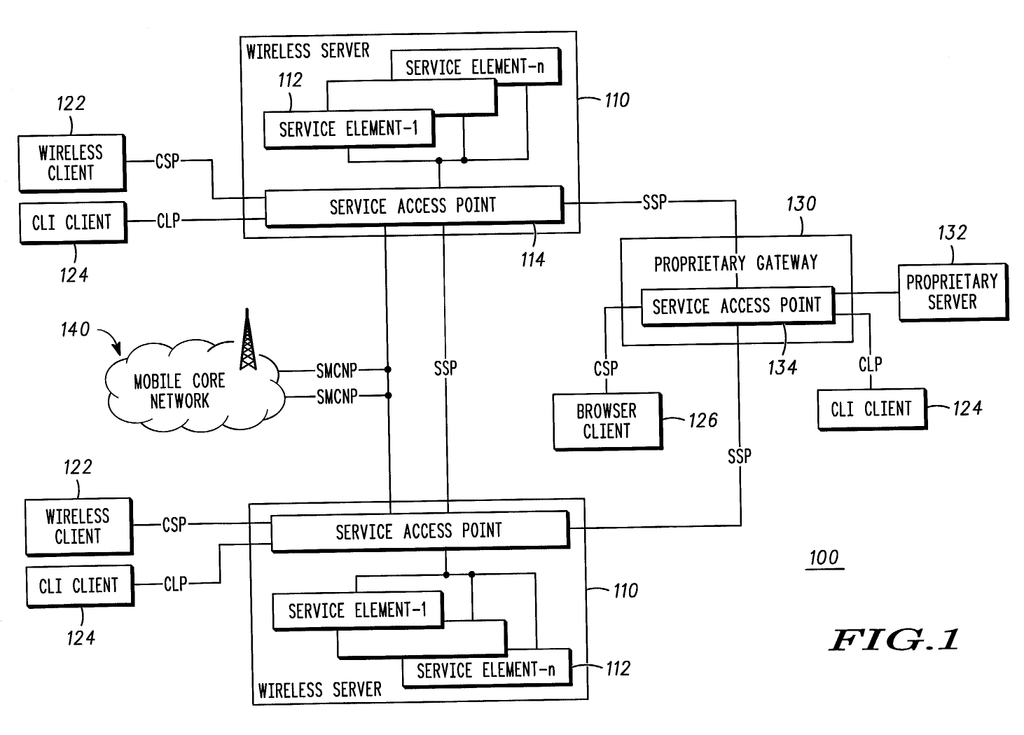

In FIG. 1, exemplary communications architecture 100 comprises at least one wireless server 110 including one or more service functionality elements 112, at least one of which is a group service element discussed more fully below. In systems having multiple servers 110, the servers communicate through corresponding service access points 114 using a server-server protocol (SSP).

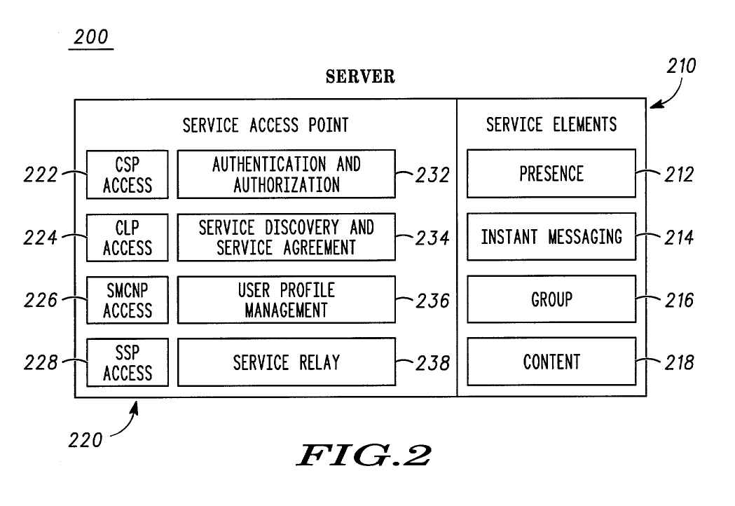

FIG. 2 illustrates an exemplary server 200 comprising a plurality of service elements 210 including presence service functionality 212, instant messaging (IM) functionality 214, information-sharing group functionality 216, and content sharing functionality 218. In the present inventions, the server provides at least group service functionality, although in other embodiments the server may provide other service functionality, including combinations of the service elements illustrated in the exemplary embodiment. The server 200 may be a wireless server, as illustrated in FIG. 1, or it may be a non-wireless server accessible. The server is accessible generally by wireless and wire-line clients.

In FIG. 1, the exemplary wireless server 110 provides service access to various wireless clients 122 communicating with a client-server protocol (CSP), and wireless clients 124 communicating with a command line interface (CLI) protocol. Other clients, including wireless clients and browser-based clients 126 among others, may access the wireless server 110 via a proprietary gateway 130, coupled to a proprietary server 132, having a corresponding access point 134, which communicates with the service access point 114 of the wireless server 110 via a server-server protocol (SSP). Browser based clients may be wireless or wireline, including for example Internet service provider (ISP) subscribers.

In FIG. 2, the server access point 220 comprises a client-server protocol (CSP) access element 222 for communicating with directly with clients, for example the wireless clients 122 running group applications in FIG. 1. In some embodiments, the wireless clients 122 comprise embedded group application software written, for example, in C-programming language. In other embodiments, the wireless clients 122 comprise JAVA based group application software in J2ME.

In FIG. 2, the server access point 220 comprises a command-line protocol (CLP) access element 224 for communicating with directly with command line interface legacy wireless clients, for example 2-way short messaging service (SMS) devices and other legacy devices.

In FIG. 1, the exemplary wireless server 110 also communicates with a mobile core network 140 via a server mobile core network protocol (SMCNP). In FIG. 2, the server access point 220 comprises an SMCNP access element 226 for communicating with the mobile core network 140. The server access point 220 comprises an SSP access element 228 for communicating with the other servers, for example the proprietary server gateway 130 in FIG. 1, using a server-server protocol.

In FIG. 2, the service access point 220 includes client authentication and authorization functionality 232, service discovery and agreement functionality 234, user profile management functionality 236, and service relay functionality 238. In some embodiments, the service access point 220 is located physically with the server service elements, but more generally the service access point 220 may be a gateway separated physically from the service elements server.

The information-sharing group service element provided by the server includes, the provision of news and discussion groups, chat rooms, and generally any other group type. The groups may be created generally either by the server or by a client.

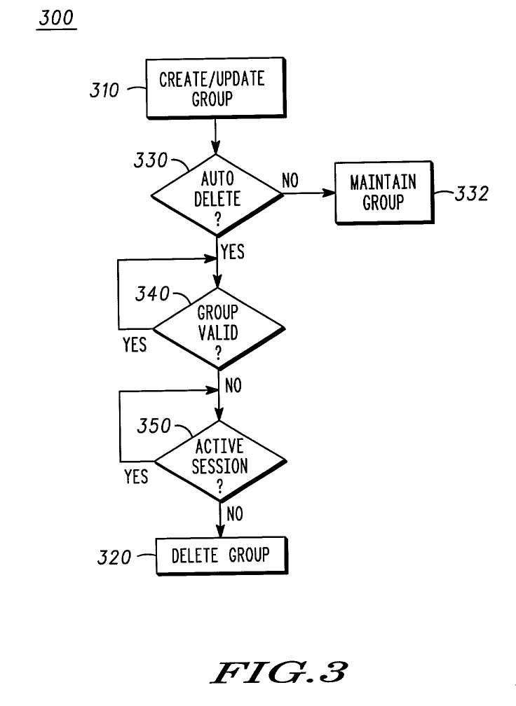

In the process flow diagram 300 of FIG. 3, at block 310, a group is created either by the service provider or by a client, for example by subscribers wireless and others having authorized access to the server. In some embodiments, for example, the group is created by a client logged onto the server in a create group transaction wherein group properties are specified by the group creator. User interfaces and applications enabling group creation are well known generally. In other applications, group properties for a previously established group are revised or updated. Upon creating or updating the group, the new or updated group is established on the server. In some embodiment, the group is created at a client or the properties of a previously created group are changed at a client and communicated to the server, whereupon the group is established or it properties are revised on the server.

In one embodiment, after establishing an information-sharing group on the communications server, which includes the creation of a new group or changing one or more properties of a previously created group, the information-sharing group is automatically deleted from the server upon expiration of a specified time period associated with the information-sharing group, as illustrated at block 320 in FIG. 3.

In one embodiment, the creator specifies whether the group will be deleted automatically, for example by selecting or setting an auto-delete group property or otherwise associating with the group an instruction to automatically delete the group, either upon creation of the group or by updating the group properties afterwards. In FIG. 3, at block 330, a determination is made whether the group is to be deleted automatically. If auto-delete has not been specified for the group, at block 332, the server maintains the information-sharing group without automatically deleting the group. In FIG. 3, if the group has been designated for automatic deletion, it will be deleted, at block 320, upon expiration of the time period associated therewith.

In one embodiment, the user specifies the time period associated with the information-sharing group, for example by specifying setting a group validity time period property, indicating how long the associated group exists before being automatically deleted. In embodiments where it is specified that the information-sharing group will be deleted automatically, the group validity time period may be set by the group creator, or alternatively the group validity time period may assume a default value, is not selected by the creator.

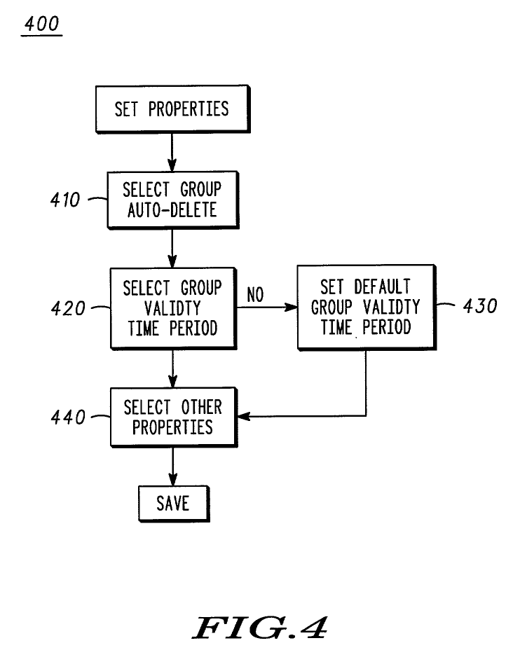

FIG. 4 is a partial information-sharing group creation or property update process flow chart 400. At block 410, whether or not the group will be deleted automatically is specified, and at block 420 the group validity time period is selected. At block 430, a default group validity time period is set if a value is not specified by the group creator/editor. At block 440 other group properties may be specified.

FIG. 5 is a schematic diagram of an exemplary group configuration file 500, which may be stored for example in a communications server, specifying group properties. The group configuration file may be used by, and in some embodiments constitutes a part of, a server-based group application program.

The group configuration file is associated with a particular group, for example by relating the group configuration data file to the unique group identification information of the group with which the data is associated. The group configuration file comprises generally group property data fields for storing group property data segments and other information for the corresponding group. In some embodiments, the group configuration file includes group configuration information for more than one group.

In FIG. 5, the group configuration file comprises an information-sharing group auto-delete property data field 510, which may be set TRUE or NOT TRUE. The group validity time data field thus stores information specifying whether the information-sharing group with which the group configuration file is associated will be deleted automatically from the communications server after a specified time period. When set TRUE, the information-sharing group with which the group configuration file is associated will be deleted automatically after the specified time period.

The group configuration file of FIG. 5 also comprises a group validity time period data field 520. The group validity time period data field stores group validity time period information specifying the time period during which the information-sharing group exists before being deleted automatically from the communications server. In some embodiments, the group creator selects the time period during which the information-sharing group exists prior to deletion from the communications server. Alternatively, the group validity time period assumes a default value in the absence of a selection by the group creator. The group configuration file may also include data fields for other properties and information associated with the corresponding information-sharing group.

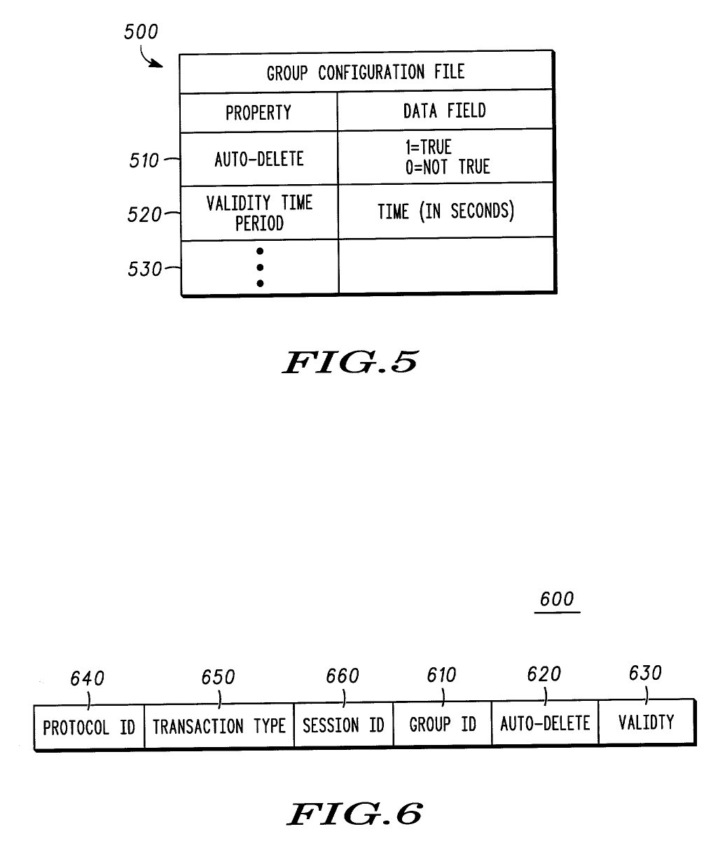

FIG. 6 illustrates a schematic application generated information-sharing group property primitive 600 for specifying properties of an information-sharing group. The exemplary group property primitive comprises generally a group identification 610 identifying a group with which the primitive is associated, and an information-sharing group auto-delete data segment 620 specifying a time period during which an information-sharing group identified by the unique identification data segment exists before being deleted automatically.

In some embodiments, the application generated information-sharing group property primitive 600 also comprises a validity time period data segment 630 specifying a time period during which the information-sharing group identified by the group identification exists before being deleted automatically. In embodiments, where this validity time period data segment is not included, as default time period may be applied.

In FIG. 6, the exemplary application generated information-sharing group property primitive includes a protocol identification data segment 640 identifying the group protocol. In some embodiments, the protocol identification data segment includes protocol version data. The exemplary application generated information-sharing group property primitive 600 also includes a protocol transaction type data segment 650, for example identifying the transaction as a property setting transaction. The exemplary application generated information-sharing group property primitive also comprises a session identification data segment 660, including for example, login information, user-identification, password, etc. The application generated information-sharing group property primitive may also include other property data fields.

In one embodiment, the application generated information-sharing group property primitive is a client application generated information-sharing group property primitive that is generated by a client application, for example from a group application running on a wireless communications client device. In other embodiments, the primitive may be generated by a server application.

In embodiments where the auto-delete and the validity time period properties are generated by an client application generated group property primitive, the group property primitive including an information-sharing group auto-delete data segment and any information-sharing group validity time period data segment are transmitted from the client, for example from a wireless communications device, to the communications server on which the information-sharing group is hosted.

In FIG. 3, at block 340, the group is maintained until the specified or default group validity time period expires, whereupon the group is deleted or removed automatically from the server. In some embodiments, at block 350, the group is deleted after expiration of the validity time period only if no users or members are actively participating in the information-sharing group. Thus if the group is active upon expiration of the group time period, the group will not be deleted until the last member leaves the group.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a communications server, comprising:
establishing an information-sharing group on the communications server;
automatically deleting the information-sharing group from the communications server upon expiration of a specified time period associated with the information-sharing group.

2. The method of claim 1,
receiving an information-sharing group property primitive from a client, the information-sharing group property primitive including information-sharing group auto-delete information and information-sharing group validity time period information,
the information-sharing group auto-delete information specifying that the information-sharing group be deleted automatically, the information-sharing group validity time period information specifying how long the information-sharing group exists before being deleted automatically.

3. The method of claim 1, specifying the time period associated with the information-sharing group by specifying a group validity time period, automatically deleting the information-sharing group upon expiration of the group validity time period.

4. The method of claim 3, automatically deleting the information-sharing group upon expiration of the group validity time period only when the there are no group members actively participating in the information-sharing group.

5. The method of claim 3, specifying the group validity time period as a validity property of the information-sharing group upon creating the information-sharing group.

6. The method of claim 1, setting an auto-delete property of the information-sharing group, automatically deleting the information-sharing group from the communications server upon expiration of the specified time period associated with the information-sharing group only if the auto-delete property of the information-sharing group is set.

7. The method of claim 1, associating the specified time period with the information-sharing group by specifying the specified time period as a property of the information-sharing group.

8. The method of claim 1, receiving, at the communications server, an instruction from a client for automatically deleting the information-sharing group after the specified time period.

9. The method of claim 8, receiving, at the communications server, an instruction from the client specifying the time period during which the information-sharing group exists before automatically deleting the information-sharing group.

10. A group configuration file associated with an information-sharing group in a communications server, comprising:
an information-sharing group auto-delete data field,
the information-sharing group auto-delete data field for storing auto-delete information specifying whether the information-sharing group with which the group configuration file is associated will be deleted automatically from the communications server after a specified time period.

11. The group configuration file of claim 10,
a group validity time period data field,
the group validity time period data field storing group validity time period information specifying a time period during which the information-sharing group with which the group configuration file is associated exists before being automatically deleted.

12. An application generated information-sharing group property primitive, comprising:
a group identification;
an information-sharing group auto-delete data segment;
an information-sharing group validity time period data segment,
the information-sharing group auto-delete data segment specifying that an information-sharing group identified by the group identification be deleted after a specified time period.

13. The application generated information-sharing group property primitive of claim 12, a validity time period data segment specifying a time period during which the information-sharing group identified by the group identification exists before being deleted automatically.

14. The application generated information-sharing group property primitive of claim 12 is a client application generated information-sharing group property primitive.

15. The application generated information-sharing group property primitive of claim 12 is a mobile wireless communications device client application generated information-sharing group property primitive.

16. The application generated information-sharing group property primitive of claim 12, comprises a protocol identification data segment, a transaction type data segment, a session identification data segment.

17. A method in an information-sharing group server, comprising:
specifying whether an information-sharing group hosted by the server is to be deleted automatically at a future time;
specifying an information-sharing group validity time period during which the information sharing group exists before being deleted automatically.

18. The method of claim 17, specifying the information sharing group validity time period by using default information-sharing group validity time period information.

19. The method of claim 17, specifying a time period during which the information sharing-group exists before being deleted automatically by receiving at the server, from a client, an information-sharing group property primitive including an information-sharing group auto-delete data segment and an information sharing group validity time period data segment.

20. The method of claim 17, receiving at the server an information sharing group property primitive from a client, the information sharing group property primitive including an information sharing group auto-delete instruction specifying whether the information sharing group hosted by the server is to be deleted automatically.

21. The method of claim 17, receiving at the server an information-sharing group property primitive from a client, the information sharing group property primitive including an information sharing group auto-delete instruction specifying whether the information-sharing group hosted by the server is to be deleted automatically, the information-sharing group property primitive including an information-sharing group validity instruction specifying the information-sharing group validity time period.

22. A method in a group application on a wireless communication client, comprising:
specifying whether an information-sharing group hosted on a server is to be deleted automatically at a future time;
specifying an information-sharing group validity time period during which the information-sharing group exists before being deleted automatically.

23. The method of claim 22, specifying a time period during which the information-sharing group exists before being deleted automatically by transmitting an information-sharing group property primitive including an information-sharing group auto-delete data segment and an information-sharing group validity time period data segment.

24. The method of claim 22, transmitting the information-sharing group property primitive including an information sharing group auto-delete data segment and an information-sharing group validity time period data segment to the server on which the information-sharing group is hosted.
